(19) United States
(12) Patent Application Publication
(10) Pub. No.: US 2017/0282265 A1
(43) Pub. Date: Oct. 5, 2017

(54) Apparatus for cutting and measuring length of an object that is long and narrow

(71) Applicant: Chun Shing Wong, Hong Kong (HK)

(72) Inventor: Chun Shing Wong, Hong Kong (HK)

(21) Appl. No.: 15/090,617

(22) Filed: Apr. 4, 2016

(51) Int. Cl. B23D 59/00

(52) U.S. Cl. CPC B23D 59/001

(57) ABSTRACT

According to embodiments of the invention, apparatuses and methods are provided for measuring and cutting elongated objects such as pipes, steel beams, etc. The apparatus may employ a precisely calibrated wheel for measuring length of a generally straight, elongated object by translation of rotational distance along an outer circumference thereof. The apparatus may further employ a lift slider, a scale, cutter, and/or a conveying structure which are generally confined to the proximity of a body frame.

### FIELD OF THE INVENTION

The present invention generally relates to machining and tooling, and more specifically relates to accurately measuring and cutting lengths of material.

### BACKGROUND OF THE INVENTION

Pipes, steel bars, and other steel strip materials in various fields are widely manufactured and used. Cutting a strip or length of material generally requires manual input and operation by a user. Cutting the length of the strip material is often deemed difficult to control. Further, cutting such material with a desirable size is often inaccurate and as a result, inefficient. Therefore, it becomes work requiring high labor intensity.

More specifically, when using table saws, mitre saws, sliding saws, and similar cutting tools, it is standard practice to measure from one end of the length of a piece of material to be cut from a larger piece, and make a marking at the point where the cutting is to occur. The larger piece of material is then put in position on a support surface of the saw so that the marking is aligned with the saw blade, after which the piece of material is sawed in two at the marking by visual alignment of the saw blade with the marking. Among the problems with this procedure are (1) the need for manually measuring the length of the piece of material to be cut and then making a mark on the piece of material as close to the measured location of cutting as possible, and (2) the need for visually lining up the saw blade with respect to the marking to cut the piece of material at a location to hopefully yield a piece of material whose length corresponds to the measured length, and in turn, the desired length. Of course, if the marking is slightly offset from the desired measured distance, then the resulting piece of material will not meet the desired length. Also, where successive pieces of material are to be measured and cut, it is difficult to successively cut the pieces of material to have the same length. That is, each subsequent piece of material will be off by a bit, thus compounding the errors. Finally, it may be time consuming to first measure the desired length to be cut, and then properly align the mark with the saw blade prior to cutting.

Prior art apparatuses seek to streamline and improve this process by introducing a tape measure or similar elongated measurement means. However, tape measures and measuring scales are either very long or require a longer working space. As such, there exists a need for an apparatus that can handle both measuring and cutting, contemporaneously, while maintaining a small physical footprint.

### SUMMARY OF THE INVENTION

According to embodiments of the invention, apparatuses and methods are provided for measuring and cutting elongated objects such as pipes, steel beams, etc. The apparatus may employ a precisely calibrated wheel for measuring length of a generally straight, elongated object by translation of rotational distance along an outer circumference thereof. The apparatus may further employ a lift slider, a scale, cutter, and/or a conveying structure which are generally confined to the proximity of a body frame.

In one embodiment of the disclosed technology, an apparatus is provided for cutting and measuring length of an object that is long and narrow. The apparatus may be composed of one or more of the following components: a) a body frame (1); b) a conveying structure (2) attached to the body frame, wherein the conveying structure (2) carries the object; c) a cutting structure adapted to the object (3); d) a wheel (4) configured to measure moving distance of the object, wherein the wheel is associated with a shaft (40) that is rotating with the wheel, the shaft (40) including a driving wheel (41); e) a meter resetting device that is used to measure resetting positions of the movable structure (5); and/or f) a movable structure (5) that is configured to slide vertically and connected to the wheel (4) via the driving wheel (41), the movable structure (5) configured to measure rotational distance of the wheel (4), further comprising: i) a lift slider (51); and ii) a scale (52) affixed to an upper portion of the lift slider (51), the lift slider (51) moving upward as the driving wheel (41) rotates.

In a further embodiment, the scale (52) may further include a hitting element (521). The hitting element (521) may include a switch (522) on an upper portion of the hitting element (521), said switch (522) connecting to the meter resetting device, as scale (52) moves up to a pre-determined position, hitting element (521) makes contact with the switch (522) causing the switch (522) actuate the meter resetting device to reset position of the movable structure (5). The driving wheel (41) may be connected to the shaft (40) through a shaft cover. The shaft (4) may include a movable wheel, which, when actuated by the meter resetting device, connects the driving wheel (41) and causes the driving wheel (41) to rotate.

In a further embodiment of the disclosed apparatus, the movable structure (5) includes a computing sensor configured to compute number of resetting positions by the meter resetting device, said computing sensor connects to a controlling device, said controlling device is connected to the cutting structure (3) for cutting operation of the object. The controlling device may further include and control a frame structure associated with the switch (522). The frame structure is movable so that the controlling device is configured to adjust a vertical position of the switch (522) as a pre-determined number of resetting positions are reached, as detected by the computing sensor.

In a further embodiment, the driving wheel (41) may include a gear. The lift slider (51) may include a protruded portion (511) that is associated with the driving wheel (41). The diameter of the driving wheel (41) may be substantially the same as diameter of the wheel (4) configured to measure moving distance of the object. Furthermore, the circumference of the wheel (4) may be configured to measure the moving distance of the object as an integer that is multiplied by 0.5 meters. That is, the number of complete rotations of the wheel may be multiplied by 0.5 meters (or whatever the circumference is) in order to stipulate total length. This may be carried out by a computing device and/or processor associated with the apparatus.

A better understanding of the disclosed technology will be obtained from the following brief description of drawings illustrating exemplary embodiments of the disclosed technology.

### BRIEF DESCRIPTION OF THE DRAWINGS

FIG. 1 shows a perspective view of an apparatus according to embodiments of the disclosed technology.

FIG. 2 shows a perspective view of the apparatus having a hitting element according to embodiments of the disclosed technology.

FIG. 3 shows a perspective view of the apparatus having a lift slider according to embodiments of the disclosed technology.

FIG. 4 shows a high-level block diagram of a microprocessor device that may be used to carry out the disclosed technology.

A better understanding of the disclosed technology will be obtained from the following detailed description of embodiments of the disclosed technology, taken in conjunction with the drawings.

### DETAILED DESCRIPTION

References will now be made in detail to the present exemplary embodiments, examples of which are illustrated in the accompanying drawings. Certain examples are shown in the above-identified figures and described in detail below. In describing these examples, like or identical reference numbers are used to identify common or similar elements. The figures are not necessarily to scale and certain features and certain views of the figures may be shown exaggerated in scale or in schematic for clarity and/or conciseness.

According to embodiments of the invention, apparatuses and methods are provided for measuring and cutting elongated objects such as pipes, steel beams, etc. The apparatus may employ a precisely calibrated wheel for measuring length of a generally straight, elongated object by translation of rotational distance along an outer circumference thereof. The apparatus may further employ a lift slider, a scale, cutter, and/or a conveying structure which are generally confined to the proximity of a body frame.

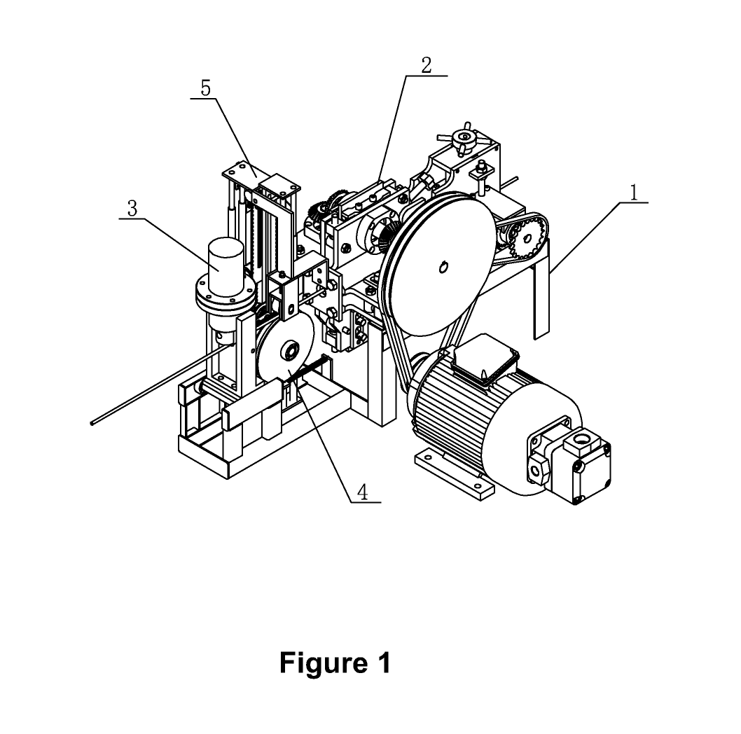

Referring now to FIG. 1, a perspective view is shown of an apparatus according to embodiments of the disclosed technology. In one embodiment of the disclosed technology, the apparatus is used for cutting and measuring length of an object that is long and narrow. The apparatus may be composed of one or more of the following components: a) a body frame (1); b) a conveying structure (2) attached to the body frame (1), wherein the conveying structure (2) carries the object to be cut; c) a cutting structure (3) adapted to cut the object; d) a wheel (4) configured to measure moving distance of the object; and e) a movable structure which moves relative to the frame (1).

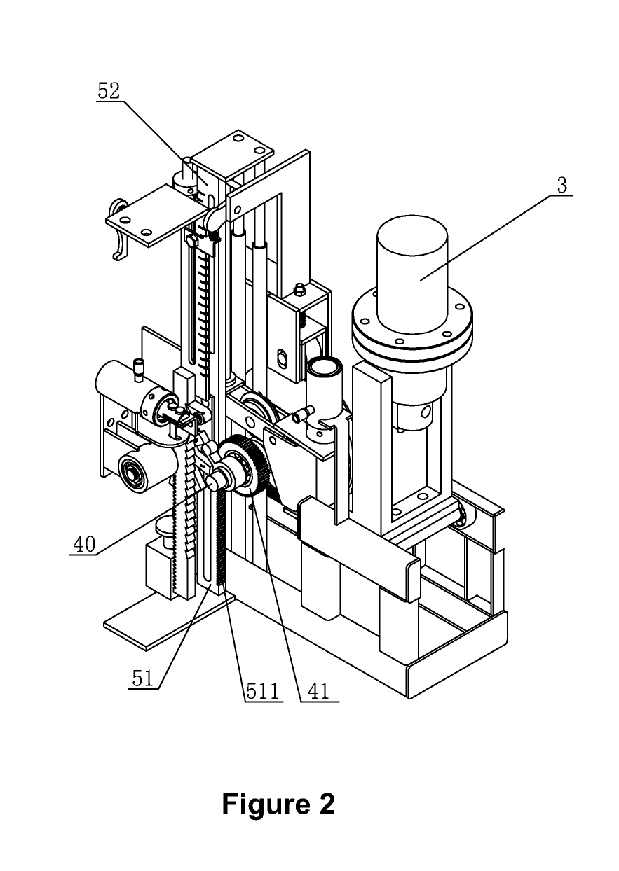

FIG. 2 shows a perspective view of the apparatus having a hitting element according to embodiments of the disclosed technology. A shaft (40) and driving wheel (41) are depicted in this view. The wheel is associated with a shaft (40) that is rotating contemporaneously with the wheel. The shaft (40) includes a driving wheel (41) which is used to drive the wheel. The movable structure (5) is configured to slide vertically and connected to the wheel (4) via the driving wheel (41). The movable structure (5) is further configured to measure rotational distance of the wheel (4). A meter resetting device may be provided to measure resetting positions of the movable structure (5).

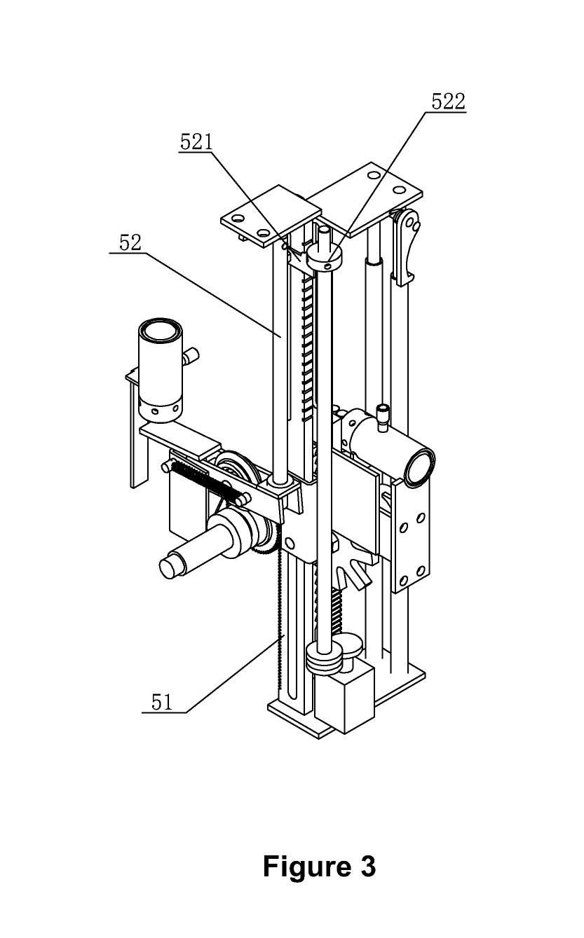

FIG. 3 shows a perspective view of the apparatus having a lift slider according to embodiments of the disclosed technology. The lift slider (51) has an associated a scale (52) affixed to an upper portion thereof. The lift slider (51) is movable upwards as the driving wheel (41) rotates.

In a further embodiment, the scale (52) may further include a hitting element (521). The hitting element (521) may include a switch (522) on an upper portion of the hitting element (521), said switch (522) connecting to the meter resetting device, as scale (52) moves up to a pre-determined position, hitting element (521) makes contact with the switch (522) causing the switch (522) actuate the meter resetting device to reset position of the movable structure (5). The driving wheel (41) may be connected to the shaft (40) through a shaft cover. The shaft (4) may include a movable wheel, which, when actuated by the meter resetting device, connects the driving wheel (41) and causes the driving wheel (41) to rotate.

In still a further embodiment of the disclosed apparatus, the movable structure (5) includes a computing sensor configured to compute number of resetting positions by the meter resetting device, said computing sensor connects to a controlling device, said controlling device is connected to the cutting structure (3) for cutting operation of the object. The controlling device may further include and control a frame structure associated with the switch (522). The frame structure is movable so that the controlling device is configured to adjust a vertical position of the switch (522) as a pre-determined number of resetting positions are reached, as detected by the computing sensor.

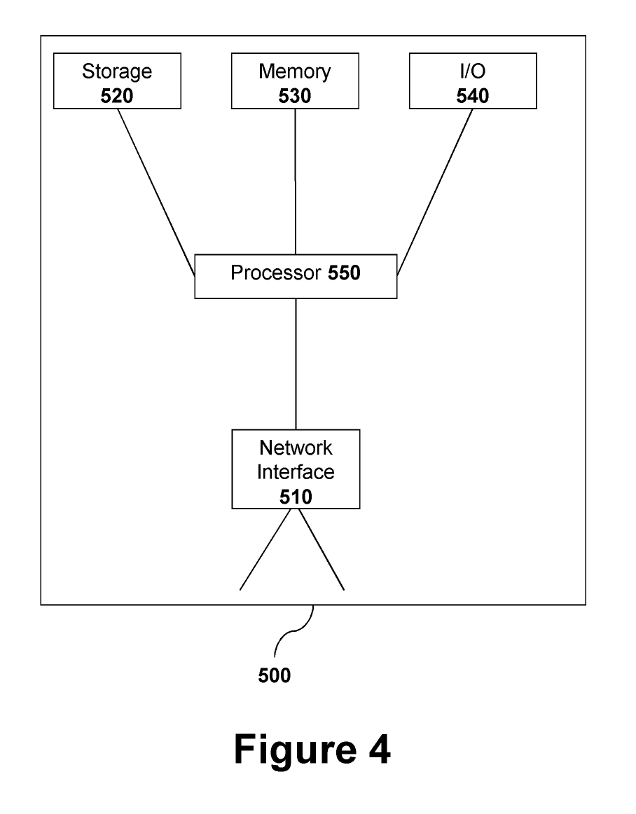

In a further embodiment, the driving wheel (41) may include a gear. The lift slider (51) may include a protruded portion (511) that is associated with the driving wheel (41). The diameter of the driving wheel (41) may be substantially the same as diameter of the wheel (4) configured to measure moving distance of the object. Furthermore, the circumference of the wheel (4) may be configured to measure the moving distance of the object as an integer that is multiplied by 0.5 meters. That is, the number of complete rotations of the wheel may be multiplied by 0.5 meters (or whatever the circumference is) in order to stipulate total length. This may be carried out by a computing device and/or processor associated with the apparatus (described with respect to FIG. 4). Any circumference or length may be used. For larger applications, the wheel may have a 2 meter radius for example. Likewise, for smaller jobs where preciseness is important, the wheel may have a smaller radius, such as, for example, 10 centimeters. Moreover, different sized wheels may be used on the same apparatus in order to double check measurements. Still further, a sliding ruler, tape measure, or any other length measuring device may be employed to double-checked measured lengths.

In a further embodiment, the scale (52) may further include a hitting element (521). The hitting element (521) may include a switch (522) on an upper portion of the hitting element (521), said switch (522) connecting to the meter resetting device, as scale (52) moves up to a pre-determined position, hitting element (521) makes contact with the switch (522) causing the switch (522) actuate the meter resetting device to reset position of the movable structure (5). The driving wheel (41) may be connected to the shaft (40) through a shaft cover. The shaft (4) may include a movable wheel, which, when actuated by the meter resetting device, connects the driving wheel (41) and causes the driving wheel (41) to rotate.

In a further embodiment of the disclosed apparatus, the movable structure (5) includes a computing sensor configured to compute number of resetting positions by the meter resetting device, said computing sensor connects to a controlling device, said controlling device is connected to the cutting structure (3) for cutting operation of the object. The controlling device may further include and control a frame structure associated with the switch (522). The frame structure is movable so that the controlling device is configured to adjust a vertical position of the switch (522) as a pre-determined number of resetting positions are reached, as detected by the computing sensor.

In a further embodiment, the driving wheel (41) may include a gear. The lift slider (51) may include a protruded portion (511) that is associated with the driving wheel (41). The diameter of the driving wheel (41) may be substantially the same as diameter of the wheel (4) configured to measure moving distance of the object. Furthermore, the circumference of the wheel (4) may be configured to measure the moving distance of the object as an integer that is multiplied by 0.5 meters. That is, the number of complete rotations of the wheel may be multiplied by 0.5 meters (or whatever the circumference is) in order to stipulate total length. This may be carried out by a computing device and/or processor associated with the apparatus

FIG. 4 is a high-level block diagram of a microprocessor device that may be used to carry out the disclosed technology. The device 500 comprises a processor 550 that controls the overall operation of a computer by executing the reader's program instructions which define such operation. The reader's program instructions may be stored in a storage device 520 (e.g., magnetic disk, database) and loaded into memory 530 when execution of the console's program instructions is desired. Thus, the device 500 will be defined by the program instructions stored in memory 530 and/or storage 520, and the console will be controlled by processor 550 executing the console's program instructions.

The device 500 may also include one or a plurality of input network interfaces for communicating with other devices via a network (e.g., the internet). The device 500 further includes an electrical input interface for receiving power and data. The device 500 also includes one or more output network interfaces 510 for communicating with other devices. The device 500 may also include input/output 540 representing devices which allow for user interaction with a computer (e.g., display, keyboard, mouse, speakers, buttons, etc.).

One skilled in the art will recognize that an implementation of an actual device will contain other components as well, and that FIG. 4 is a high level representation of some of the components of such a device for illustrative purposes. It should also be understood by one skilled in the art that the method and devices depicted in FIGS. 1 through 3 may be implemented on a device such as is shown in FIG. 4.

While the disclosed invention has been taught with specific reference to the above embodiments, a person having ordinary skill in the art will recognize that changes can be made in form and detail without departing from the spirit and the scope of the invention. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the invention.

The claims, description, and drawings of this application may describe one or more of the instant technologies in operational/functional language, for example as a set of operations to be performed by a computer. Such operational/functional description in most instances would be understood by one skilled the art as specifically-configured hardware (e.g., because a general purpose computer in effect becomes a special purpose computer once it is programmed to perform particular functions pursuant to instructions from program software).

What is claimed:

1. An apparatus for cutting and measuring length of an elongated object, comprising:
a body frame (1);
a conveying structure (2) attached to the body frame, wherein the conveying structure (2) holds the object;
a cutting structure adapted to cut the object (3);
a wheel (4) configured to measure moving distance of the object, wherein the wheel is associated with a shaft (40) that r with the wheel, the shaft (40) including a driving wheel (41); and
a movable structure (5) that is configured to slide vertically and connected to the wheel (4) via the driving wheel (41), wherein the movable structure (5) measures rotational distance of the wheel (4), further wherein the movable structure (5) has a lift slider (51) and a scale (52) affixed to an upper portion of the lift slider (51), wherein the lift slider (51) moves upwards as the driving wheel (41) rotates.

2. The apparatus of claim 1, wherein the body frame (1) further comprises a meter resetting device that is used to measure resetting positions of the movable structure (5).

3. The apparatus of claim 2, wherein the scale (52) has a hitting element (521), wherein the hitting element (521) has a switch (522) on an upper portion thereof, the switch (522) being connected to the meter resetting device, wherein as scale (52) moves up to a pre-determined position the hitting element (521) makes contact with the switch (522) causing the switch (522) to actuate the meter resetting device to reset a position of the movable structure (5).

4. The apparatus of claim 3, wherein the driving wheel (41) is connected to the shaft (40) through a shaft cover, further wherein said shaft (4) has a movable wheel which, when actuated by the meter resetting device, connects the driving wheel (41) and causes the driving wheel (41) to rotate.

5. The apparatus of claim 4, wherein the movable structure (5) includes a computing sensor configured to compute number of resetting positions by the meter resetting device, said computing sensor connects to a controlling device, said controlling device is connected to the cutting structure (3) for cutting operation of the object.

6. The apparatus of claim 5, wherein the controlling device further includes and control a frame structure associated with the switch (522), the frame structure is movable so that the controlling device is configured to adjust a vertical position of the switch (522) as a pre-determined number of resetting positions are reached, as detected by the computing sensor.

7. The apparatus of claim 6, wherein the driving wheel (41) includes a gear, said lift slider (51) includes a protruded portion (511) that is associated with the driving wheel (41).

8. The apparatus of claim 7, wherein diameter of the driving wheel (41) is substantially same as diameter of the wheel (4)configured to measure moving distance of the object.

9. The apparatus of claim 8, wherein circumference of the wheel (4) configured to measure moving distance of the object is an integral multiple times of 0.5 meters.
